(19) United States
(12) Patent Application Publication
(10) Pub. No.: US 2007/0005700 A1
(43) Pub. Date: Jan. 4, 2007

(54) Method for processing data

(75) Inventors: Oliver Wagner, Werther (DE); Thomas Servatius, Herzebrock-Clarholz (DE); Oliver Koster, Bielefeld (DE); Francois Houste, Lagny-Sur-Marne (FR)

Correspondence Address: HENRY M FEIEREISEN, LLC, 350 FIFTH AVENUE, SUITE 4714, NEW YORK, NY, 10118, US

(73) Assignee: LYCOS EUROPE GMBH, Gutersloh (DE)

(21) Appl. No.: 11/417,230

(22) Filed: May 3, 2006

(30) Foreign Application Priority Data
May 4, 2005 (EP) 05 009 772.4

(51) Int. Cl. G06F 15/16

(52) U.S. Cl. 709/204

(57) ABSTRACT

In a method for data processing, individual data packets of an amount of data are organized into categories, and the data packets are then sorted in the assigned categories. The sorted data is graphically processed in the assigned categories as a combined graphic display to allow individual identification of the individual data packets in the combined graphic display.

### CROSS-REFERENCES TO RELATED APPLICATIONS

This application claims the priority of European Patent Application, Serial No. 05 009 772.4, filed May 4, 2005, pursuant to 35 U.S.C. 119(a)-(d), the content of which is incorporated herein by reference.

### BACKGROUND OF THE INVENTION

The present invention relates to a method for processing data, in particular data from Web blogs (“Blogosphere”).

Nothing in the following discussion of the state of the art is to be construed as an admission of prior art.

The amount of data available to consumers has multiplied over the past decades, in particular due to the possibilities opened up by modern data processing and the widespread use of the Internet. As a result, the individual user feels increasingly challenged both in the private sphere as in the professional environment to process of this flood of information. Only an initial rational processing of the data can make the difference between a beneficial use of the data and a hopeless burden for the user.

There is an increasing need for improved data processing and data presentation associated with the steadily increasing amount of data. Conventional support, however, is essentially limited to organize the data according to user-defined search terms and to then arrange the data in hit lists. These hit lists can be sorted, for example, according to date, size, subject matter or author. However, these categories do no longer satisfy user expectations.

More recent support for data processing is based, for example, on categorizing the data according to combined keywords and terms, which the user community has assigned to certain objects, themes or phenomena. This type of categorization is known under the newly coined term “folksonomy.”

With these systems, data can advantageously be organized in a more differentiated manner. However, the disadvantage remains that the user is still unable to adequately manage the sorted data. The user is still overwhelmed by the flood of data, i.e., he has no an overview over the data available to him and can therefore also not access the data relevant for the user.

It would therefore be desirable and advantageous to provide a method and a system for processing data to obviate prior art shortcomings and to allow accessing of a large amount of data while at the same time making individual data packets from these data accessible to the user.

### SUMMARY OF THE INVENTION

According to one aspect of the present invention, a method for data processing includes the steps of organizing individual data packets of an amount of data into categories, sorting the data packets in the categories, and graphically processing the sorted data in the categories as a combined graphic display to allow individual identification of the individual data packets in the combined graphic display.

The present invention resolves prior art problems by presorting a large amount of data according to categories and to combine the data in these categories. The data are combined via a common graphic visualization. This graphic visualization provides a first overview over the amount of data obtained after sorting. However, the individual data packets can still be identified by the user within the combination and can also be retrieved, i.e., the user has direct access to the individual data packets from the graphic representation. The user can therefore directly select and also access the data packets of interest starting from a visualized categorized overall overview.

A method according to the invention therefore provides an overview over the categorized amount of data and also makes it possible to find an individual data packet within the total amount of data. The user can also integrate the individual data packet into the context of the entire amount of data. The user thereby gains additional information beyond the information contained in the individual data packet. With the method of the invention, complex data/information can then be accessed and navigated via a common interface.

The categories considered by the method according to the invention for sorting the data packets can be user-independent, user-dependent, or user-defined. For example, the data can be sorted, as with conventional methods, according to the typical categories such as date, author, file size, etc. This represents user-independent sorting. In addition or alternatively, the data can also be characterized according to, for example, the frequency with which a data packet is retrieved or according to the number of comments submitted by third parties with respect to the data packet. Because this category depends on the actual use of the data packets by the user of the data, these are referred to as user-depended categories. Alternatively, the user of the method of the invention himself may define a category (user-defined categories). It will be understood that these different categories can also be combined.

According to another feature of the present invention, the user-dependent or user-independent information can be evaluated. For example, a data packet can be sorted according to certain terms used by the respective author and the identified terms can be evaluated (qualified) by the method of the invention. This can be accomplished, for example, by assigning numerical values or scores. That graphic overview over the amount of data can then be at least partially based on the evaluation based on this scoring separation.

Many available graphic representations can be used to visually represent the amount of data, including the data packets. Advantageously, graphic elements can be used which permit a fine gradation. A fine gradation can then be assigned to an individual data packet or to a selected number of individual data packets. Advantageously, the graphic representations include the associated links of the individual data packets, which gives the user immediate access to the data packet. Alternatively, the data packet may also be identifiable only through its identification data (context information).

According to another feature of the present invention, the merging and/or evaluating visualization of the amount of data can also be limited to a predefined selection of data packets. This may be advantageous when the total number of data packets is significantly greater than a manageable number of data packets. The exact size of a selected amount of data may vary and may also be determined by the purpose for which these categories are sorted.

According to another aspect of the present invention, a system for data processing includes a data carrier for storing an amount of data which is comprised of individual data packets, an evaluation unit for organizing the data packets by assigning the data packets to defined categories and sorting the data in the assigned categories, a graphic unit receiving the sorted data from the evaluation unit and processing the sorted data to form a combined graphic display of the sorted data, and an interface for at least one user to allow the at least one user to interact with the combined graphic display.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a graphic illustration of a mood sensor (“moodometer”);

FIG. 2 shows an initial graphic illustration of a moodometer;

FIG. 3 shows schematically a visualization of weighted cells;

FIG. 4 shows schematically the use of color intensity to indicate the relevance of an entry;

FIG. 5 is a schematic logic diagram for data assembly according to the method of the invention;

FIG. 6 is a schematic flow diagram for importing data according to the method of the invention; and

FIG. 7 is a schematic process flow for computing popularity of and user reaction to blog pages.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

A method according to the present invention can be applied as a barometer of public opinion (“moodometer”) of an Internet community. The method displays a start page for this community which gives a quick overview over the following questions:
Which Web pages (entries) of the users were updated today?
What was the predominant mood of the authors of the entries?
Which entries where most frequently read?
Which entries received most frequently comments?

This information is collected, processed and visualized with the invention.

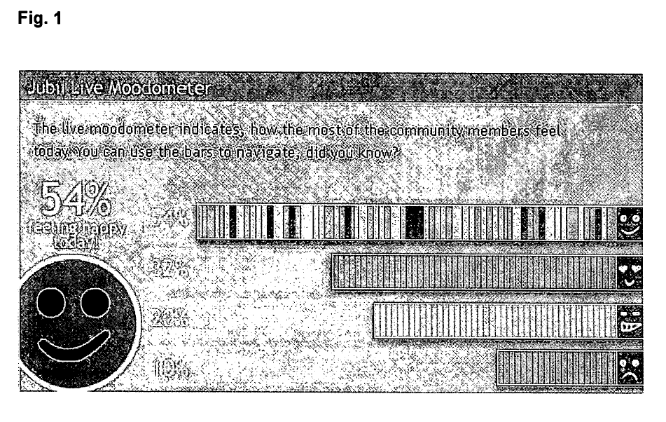

As shown in FIG. 1, a visualization of the information can be realized by four exemplary bars to symbolize four exemplary possible moods from which the user can select when submitting an entry. The moods span the range from “happy” (top bar) via “in love” (second bar from top) and “sour/aggressive” (third bar from top) to “sad” (bottom bar). This representation can be assisted by a color guide system. The mood selected by a majority of authors for the actual day is determinative for a background color of the graphic display. For example, the background color may be “orange” and correspond to the color of the top bar, since 54% of the users contributing entries associated their mood with “happy.” The second bar may be colored “pinkish”, indicating that 32% are “in love”. The third bar may be colored “greenish”, indicating that 20% have a “sour/aggressive” mood, and the bottom bar may be “bluish”, indicating that 10% are “sad”. Another example may involve a pinkish background color and pinkish top bar, while the second bar may be orange, the third bar may be greenish and the bottom bar may be bluish.

The length of each of the bars represents hereby the various moods as a relative percentage.

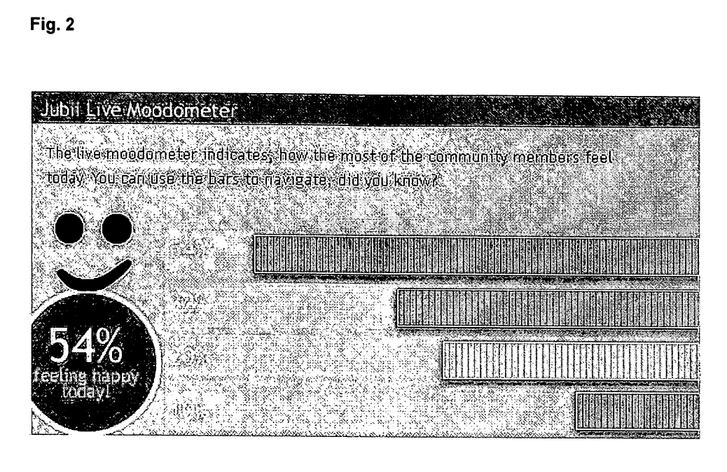

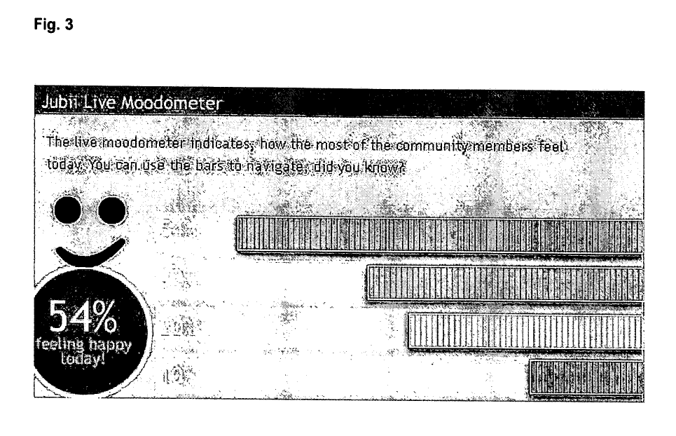

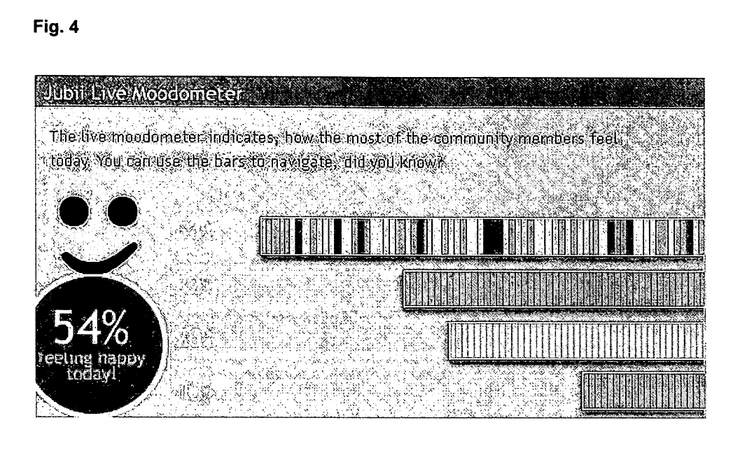

As shown in FIGS. 1 through 4, each bar is divided by vertical lines. Each subdivision represents a single data packet or an entry (posting) on a user page (blog). Initially, the subdivisions have a same width and a same color, as indicated in FIG. 2. In other words each of the bars is initially uniformly of one color. The width of the various divisions is increased depending on the number of times a posting is accessed. As a result and as indicated by the top bars of FIGS. 1 and 3, the width of the divisions for the frequently accessed postings becomes greater, which visually enhances their relevance for the viewer. In other words, the width of the cells is weighted by the number of accesses or hits. As indicated in FIGS. 1 and 3, the width of the subdivisions of the top bars increases with the number of hits a posting receives. This is one measure for the relevance of a posting.

Visual processing and rendition of the entries is also affected by comments added by individual users to the postings of a blog. It is also conceivable to emphasize the relevance of an entry through the use of color intensity. Entries with a greater number of comments or track backs received more intense colors for better visualization, thereby further enhancing its visual appearance. The basic color of the representation can vary according to a mood assigned to the entire day.

In accordance with a method of the invention, the user is thus enabled to identify the mood with which the entries were received, the frequency with which other users accessed and commented on an entry. A thematic pre-selection can already be performed according to the categories of the selected Web pages.

When the computer mouse travels across a line or division in the mood bar, information is displayed about the title of the posting and the name of the blog. The user can click on the line or field to reach the corresponding page. Thus, the subdivision of the bars enables a linkage of individual entries for retrieval by the user. By using mouseOver, the bars indicate a context information which discloses the name of the blog as well as the title of the posting. The precise entry in a respective blog can thus be retrieved per click.

Data Acquisition:

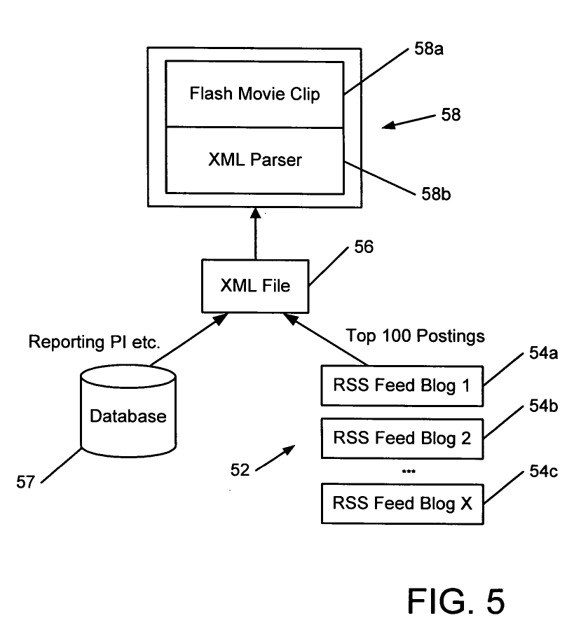

Referring now to FIG. 5, there is shown a schematic logic diagram for data assembly according to the method of the invention. The data is collected in a blogging engine 52 which makes a new entry in a RSS feed of a blog 54a, 54b, 54c each time a contribution is submitted. All RSS feeds are processed at a central location 56 and the data are split into the following information:

Mood:

Each entry (posting) is characterized by the author with a mood. As described above, the mood can span the range from “happy” via “in love” to “sour/aggressive” or “sad.” The system of the invention assigns to each mood a value between 0 and 4; wherein “0” indicates “neutral” or no assigned mood. Neutral postings are neither evaluated for the moodometer nor for the rankings. For evaluating the mood of the day and for generating the hits sorted according to the mood, this information is combined with the link to the referencing blog, title, and date of the entry and its ID, and is stored in a table, for example, in database 57.

Comments:

The blogging engine 52 transmits the number of received comments to an additional database table residing, for example, in database 56, together with the information of the blog name, the article ID and the date of the posting.

Data Processing:

A moodometer 58 imports data from the database 56 in XML format. When a start page is retrieved, an embedded flash file 58a communicates with an XML file (XML feed) 56, from which the contents are generated and visualized.

The XML file 56 includes the following attributes:
id includes the unique id of the corresponding line
name includes the page name of the page with the corresponding section to which the moodometer is linked
last includes text which is inserted in a pop-up layer over the moodometer
POPU has a value between 0 and 100 which determines the actual popularity of the corresponding page (as compared to the other 99 pages). The value “100” corresponds to the highest number of page impressions (page calls) compared to the other pages, which are provided in the XML feed. The other Web pages are computed proportionally according to the following formula:
popu site1 =(pages_imp1/pages_impTop)*100
popu site1 is the popu-value to be computed for the page
pages imp1 in the number of hits on the page for which popu_site1 is to be computed
pages ImpTop is the number of hits on the most popular page.
react is assigned a value between 0 and 100 which indicates the ratio of the reactions of the last message on the corresponding page, i.e., the ratio of the number of reactions for this page compared to the number of reactions for the other 99 pages. The page which received the most reactions to the last message receives the number 100. The react values of the other Web sites are computed in a similar manner according to the following formula:
react site1=(comment1/commentTop)*100
React site1 is the react value to be computed for the page
comment1 is the number of reactions for the page to be computed
commentTop is the number of reactions of the page which received the most reactions to the last message
mood is assigned a value from 1 to 4 which represents the mood for the last submitted message of the corresponding page

Additional information required for operating the application are loaded from another XML file. This file includes all text and basic structure of the links and is replaced within the moodometer with the contents of the name attribute, so that a complete URL is formed.

Visualization

As shown in FIG. 2 and as mentioned before, the graphic representation of the moodometer includes essentially the following elements:
Background color: this color shows the mood of the day and therefore depends on the entries of the users. In one exemplary embodiment, the background color can vary between pink, orange, green, and blue and can have a slight gradient.
A large round element includes the “Visual/Smiley” which indicates the mood of the day. Visual/Smiley's are also displayed next to the percentage bars, and the large Visual/Smiley corresponds to the Visual/Smiley of the bar having the largest percentage.
Four percentage bars representing the distribution of the postings on the various moods. The percentage bars are arranged in the order of the percentages.
The last 100 postings are each indicated by small cells, with the distribution of the cells on the bars also determined by the percentages (see FIGS. 1, 3 and 4).

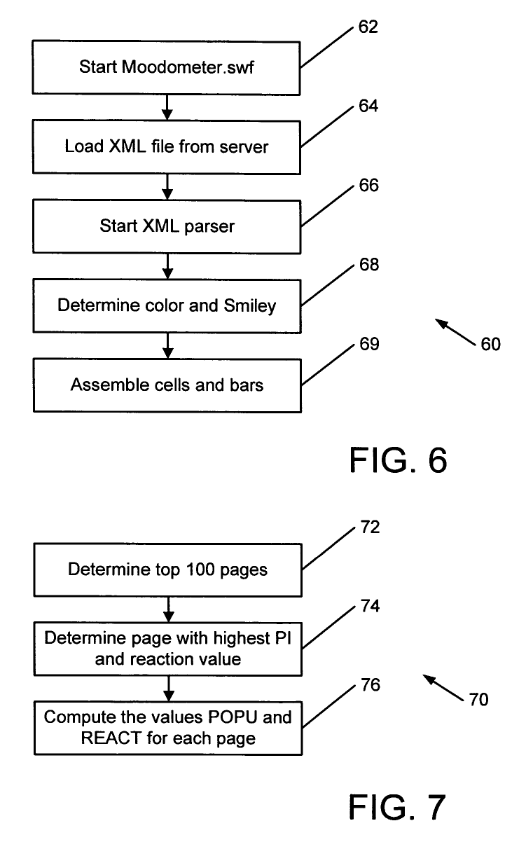

Turing now to FIG. 6, there is shown a flow diagram of a process 60 according to the invention for generating the visual diagrams of FIGS. 1-4. At step 62, the moodometer starts and loads the XML file from a server, step 64. At step 66, the XML parser 58b (FIG. 5) is started, which selects the blogs, comments, etc., as described above, and determines, at step 68, the background color, the Visual/Smiley, the percentages, etc. Finally, the cells and bars are configured at step 69.

FIG. 7 is a flow diagram of a process 70 for aggregating the top 100 pages according to the invention. At step 72, the top 100 pages are determined, as described above. At step 74, the page with the highest popularity index popu (PI=Page Impression) and the highest reaction react is determined. At step 76, the popularity indices popu sitel and the reaction values react sitel are computed for the remaining 99 pages.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for data processing, comprising the steps of:
organizing individual data packets of an amount of data into categories;
sorting the data packets in the categories; and
graphically processing the sorted data in the categories as a combined graphic display to allow individual identification of the individual data packets in the combined graphic display.

2. The method of claim 1, wherein the data are supplied by a community of users, and wherein the data packets are organized and assigned to the categories depending on use of the data packets by the users.

3. The method of claim 1, wherein the data packets are organized without input from a user.

4. The method of claim 1, wherein the categories are defined by a user, and the data packets are assigned to the user-defined categories.

5. The method of claim 1, wherein the categories are defined independent of user input, further comprising the steps of presorting the data packets according to the user-independent categories, and subsequently sorting the data packets according to a user-defined information.

6. The method of claim 1, wherein the data packets are assigned a numerical value.

7. The method of claim 1, further comprising the steps of associating a context information to a data packet, and displaying the context information when the data is graphically displayed.

8. The method of claim 1, wherein the individually identified data packets are retrievable from the graphic display.

9. The method of claim 1, wherein the process of organizing, sorting and graphically processing are repeated several times.

10. The method of claim 1, further comprising the step of selecting a subset of the data for sorting and graphic processing.

11. The method of claim 1, wherein a total amount of available data or the data packets, or both, change over time.

12. The method of claim 1, wherein an amount of the data or the data packets originate from users associated with an Internet community.

13. The method of claim 1, wherein an amount of the data or the data packets originate from users associated with a blogosphere.

14. The method of claim 2, wherein the community of users is self-organized.

15. The method of claim 2, wherein the data packets are dynamically organized and assigned to the categories depending on use of the data packets by the users.

16. A system for data processing, comprising:
a data carrier for storing an amount of data which is comprised of individual data packets;
an evaluation unit for organizing the data packets by assigning the data packets to defined categories and sorting the data in the assigned categories;
a graphic unit receiving the sorted data from the evaluation unit and processing the sorted data to form a combined graphic display of the sorted data; and
an interface for at least one user to allow the at least one user to interact with the combined graphic display.
